(19) United States
(12) Patent Application Publication
(10) Pub. No.: US 2007/0177074 A1
(43) Pub. Date: Aug. 2, 2007

(54) LIQUID CRYSTAL DISPLAY AND METHOD OF MANUFACTURING THE SAME

(76) Inventors: Yun Jang, Gunpo-si (KR); Duck-Jong Suh, Seoul (KR); Bong-Sung Seo, Yongsin-si (KR); Min-Sik Jung, Seoul (KR)

Correspondence Address: Frank Chau, Esq.;F. CHAU & ASSOCIATES, LLC, 130 Woodbury Road, Woodbury, NY, 11797, US

(21) Appl. No.: 11/566,449

(22) Filed: Dec. 4, 2006

(30) Foreign Application Priority Data
Feb. 1, 2006 (KR) 10-2006-0009700

(51) Int. Cl. G02F 1/1333

(52) U.S. Cl. 349/110

(57) ABSTRACT

A liquid crystal display includes a liquid crystal panel, the liquid crystal panel including a first substrate and a second substrate facing each other with liquid crystals interposed therebetween, wherein a light-shielding region that blocks light regardless of the arrangement of the liquid crystals is defined in each of the first substrate and the second substrate, and an ion-adsorptive cell gap maintaining member interposed between the first substrate and the second substrate so that the ion-adsorptive cell gap maintaining member is shielded by the light-shielding region of the first substrate or the second substrate.

### CROSS-REFERENCE TO RELATED APPLICATION

This application claims priority from Korean Patent Application No. 10-2006-0009700 filed on Feb. 1, 2006, the disclosure of which is incorporated herein by reference in its entirety.

### BACKGROUND OF THE INVENTION

1. Technical Field

The present disclosure relates a flat panel display and a method of manufacturing the same, and more particularly, to a liquid crystal display having a higher voltage holding ratio and a lower residual direct current and a method of manufacturing the same.

2. Discussion of the Related Art

A liquid crystal display is a widely-used flat panel display, and comprises two substrates including electrodes and a liquid crystal layer interposed between the two substrates. When voltages are applied to the electrodes of the two substrates, an electric field is generated in the liquid crystal layer, and liquid crystals in the liquid crystal layer are rearranged, thereby adjusting the amount of transmitted light.

The liquid crystal display includes an alignment film that causes the liquid crystals to be aligned in a predetermined direction. The alignment film may comprise a polymer resin, e.g., polyimide. Thus, the alignment film may be degraded by light according to, for example, the operating environment or the operating time of the liquid crystal display. A process such as, for example, a curing process or a rubbing process, used in forming the alignment film comprising, for example, polyimide may increase a process duration. Static electricity created by the rubbing process may lower the reliability of the liquid crystal display.

To enhance the reliability of the liquid crystal display and to reduce the number of processes and the process duration, an alignment film comprising polyimide, the alignment film been used. When compared to an alignment film comprising polyimide, the alignment film comprising the inorganic material has better light stability and can be formed to a uniform thickness using a plasma-enhanced thin film process without performing the rubbing process creating the static electricity.

When the alignment film comprising the inorganic material is used, however, ionic impurities floating in the liquid crystal layer may cause, for example, a low Voltage Holding Ratio (VHR), and a residual Direct Current (DC), thereby lowering brightness and leaving an afterimage on a screen.

### SUMMARY OF THE INVENTION

According to an embodiment of the present invention, a liquid crystal display includes a liquid crystal panel, the liquid crystal panel including a first substrate and a second substrate facing each other with liquid crystals interposed therebetween, wherein a light-shielding region that blocks light regardless of the arrangement of the liquid crystals is in each of the first substrate and the second substrate, and an ion-adsorptive cell gap maintaining member interposed between the first substrate and the second substrate so that the ion-adsorptive cell gap maintaining member is shielded by the light-shielding region of the first substrate or the second substrate.

According to an embodiment of the present invention, a method of manufacturing a liquid crystal display includes a liquid crystal panel, the method including forming an ion-adsorptive cell gap maintaining member between a first substrate and a second substrate, each substrate comprising a light-shielding region blocking light regardless of the arrangement of liquid crystals, wherein the ion-adsorptive cell gap maintaining member is shielded by the light-shielding region of the first substrate or the second substrate, and combining the first substrate and the second substrate together.

### BRIEF DESCRIPTION OF THE DRAWINGS

Exemplary embodiments of the present disclosure can be understood in more detail from the following description taken in conjunction with the accompanying drawings of which:

FIG. 1 is a schematic exploded perspective view illustrating a liquid crystal display according to an embodiment of the present invention;

FIG. 2 is a plan view illustrating a liquid crystal display according to an embodiment of the present invention;

FIG. 3 is a layout of a liquid crystal display according to an embodiment of the present invention;

FIGS. 4 through 7 are sectional views taken along the line IV-IV′ of FIG. 3 according to embodiments of the present invention; and

FIGS. 8 through 11C illustrate methods of manufacturing liquid crystal displays according to embodiments of the present invention.

### DETAILED DESCRIPTION OF EXEMPLARY EMBODIMENTS

Exemplary embodiments of the present invention will be described in more detail with reference to the accompanying drawings. The present invention may, however, be embodied in many different forms and should not be construed as limited to the embodiments set forth herein.

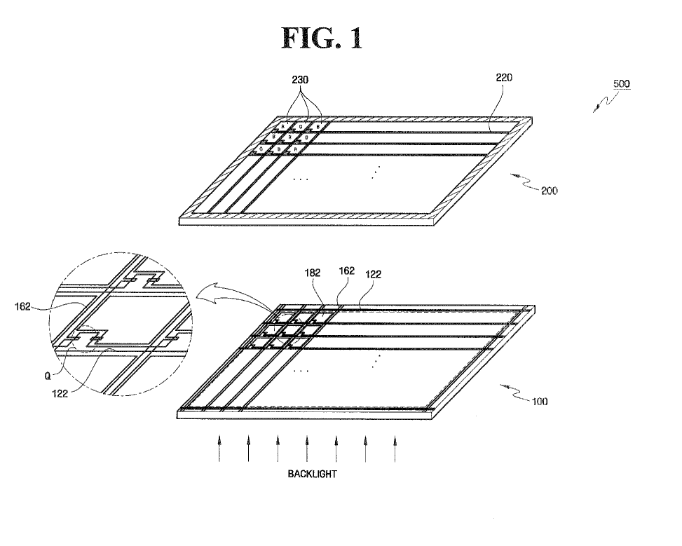

A liquid crystal display according to an embodiment of the present invention is described with reference to FIGS. 1 through 4.

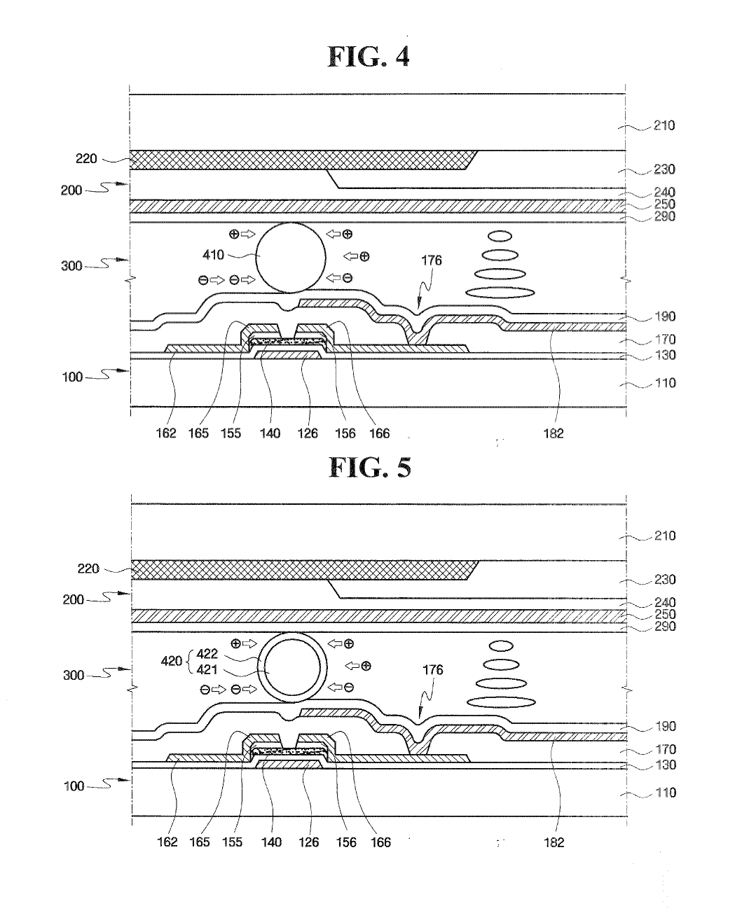

FIG. 1 is a schematic exploded perspective view illustrating a liquid crystal display according to an embodiment of the present invention. Referring to FIGS. 1 and 4, a liquid crystal display 500 has a liquid crystal panel including a first substrate 100 and a second substrate 200 facing each other with a liquid crystal layer 300 interposed therebetween, and a cell gap maintaining member 410 maintaining a cell gap between the first substrate 100 and the second substrate 200.

The first substrate 100 includes a plurality of gate lines 122 which extend parallel to one another in a first direction on a first insulating substrate 110, and a plurality of data lines 162 which extend parallel to one another in a second direction. The plurality of gate lines 122, a storage electrode line (not shown) and the data lines 162 may comprise an opaque conductive material, such as, for example, aluminum (Al), copper (Cu), silver (Ag), molybdenum (Mo), chromium (Cr), titanium (Ti), tantalum (Ta), or an alloy thereof, and may comprise a single-layered structure or a multi-layered structure of two or more layers. According to an embodiment of the present invention, each of the plurality of gate lines 122 crosses substantially perpendicular to each of the data lines 162, thereby defining a pixel. A thin film transistor Q and a pixel electrode 182 switched by the thin film transistor Q are provided at the pixel. A gate electrode 126 of the thin film transistor Q is branched from a corresponding one of the plurality of gate lines 122.

The second substrate 200 includes a black matrix 220 formed in a lattice shape and a color filter pattern 230 on a second insulating substrate 210. The black matrix 220 comprises an opaque material, and is formed along the boundary of a pixel area to define each pixel. In the color filter pattern 230, a red color filter, a green color filter, and a blue color filter are alternately arranged. Each of the respective color filters is surrounded by the black matrix 220. In an embodiment of the present invention, the width of the black matrix 220 may be about 30 to about 40.

The first substrate 100 and the second substrate 200 may be sealed to each other with the liquid crystals interposed therebetween. In an embodiment of the present invention, the plurality of gate lines 122 and the plurality of data lines 162 provided on the first substrate 100 are aligned to overlap the black matrix 220 of the second substrate 200.

A backlight unit (not shown) can be disposed at the first substrate 100. Light emitted from the backlight unit is transmitted through the first substrate 100, the liquid crystal layer 300, and the second substrate 200. When the light emitted from the backlight unit is blocked by one of the first substrate 100, the liquid crystal layer 300, and the second substrate 200, the light cannot be transmitted through the liquid crystal display panel. The transmission or blocking of light in the liquid crystal layer 300 is determined by the electric field in the liquid crystal layer 300. A region blocking light regardless of the electric field in the liquid crystal layer 300 is referred to as a “light-shielding area” of the liquid crystal display panel. The light-shielding area of the liquid crystal display panel comprises a light-shielding area of the first substrate 100 and a light-shielding area of the second substrate 200. A region, excluding the light-shielding area of the liquid crystal display panel, i.e., a region transmitting light according to the electric field is referred to as a “transmitting region.”

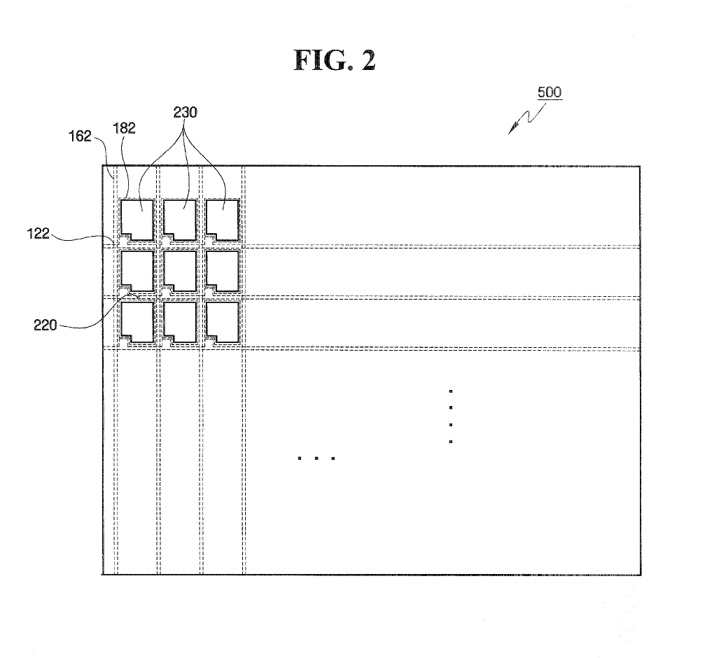

FIG. 2 is a plan view illustrating a liquid crystal display according to an embodiment of the present invention. Referring to FIG. 2, dotted lines represent gate lines 122, data lines 162, and pixel electrodes 182 of the first substrate 100 of the liquid crystal display 500.

The gate lines 122 and the data lines 162 of the first substrate 100, and the black matrix 220 of the second substrate 200 create light-shielding regions. The black matrix 220 of the second substrate 200 is aligned to overlap the gate lines 122 and the data lines 162 of the first substrate 100 to minimize the light-shielding regions. The black matrix 220 has a wider width than each of the gate lines 122 and the data lines 162 to prevent a light leakage phenomenon and to enhance visibility of the liquid crystal display 500. That is, the black matrix 220 may cover the gate lines 122 and the data lines 162.

Regions where the pixel electrodes 182 of the first substrate 100 overlap the color filter pattern 230 of the second substrate 200 are transmitting regions. The color filter pattern 230 and the pixel electrodes 182 may overlap each other so that the color filter pattern 230 can be covered with the pixel electrodes 182.

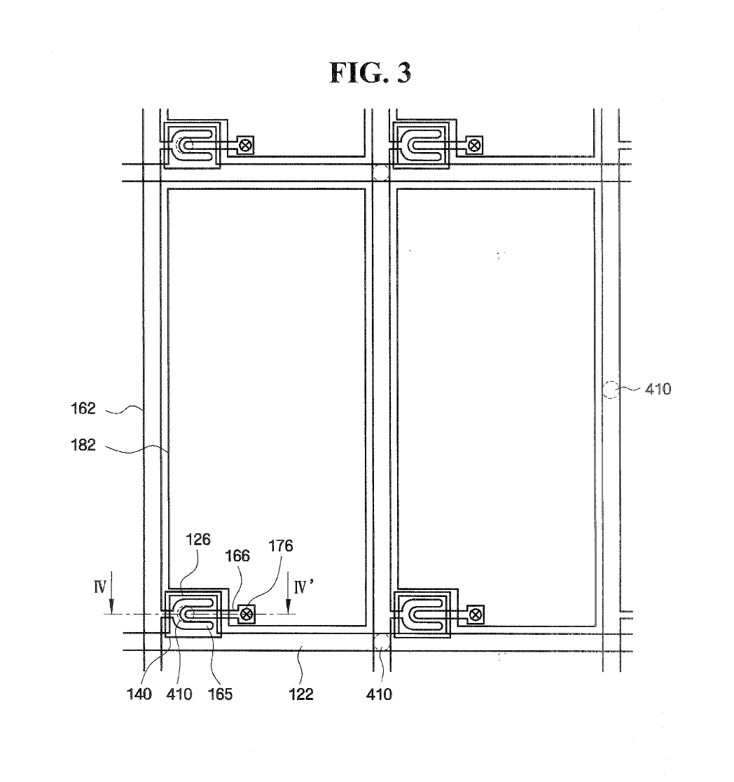

FIG. 3 is a layout of a liquid crystal display according to an embodiment of the present invention. FIG. 4 is a sectional view taken along the line IV-IV′ of FIG. 3.

Referring to FIGS. 3 and 4, a plurality of gate wires for gate signal transmission are disposed on the insulating substrate 110. The plurality of gate wires include the gate lines 122, a gate line pad (not shown), and the gate electrode 126. Each gate line 122 extends in a first direction (in a transverse direction of FIG. 3). The gate line pad is connected to an end of the gate line 122, and receives a gate signal from an external source and transmits the received gate signal to the gate line 122. The gate electrode 126 of the TFT is connected to the gate line 22 and has a protrusion shape. The plurality of gate wires 122 and 126 may comprise, for example, Al, Cu, Ag, Mo, Cr, Ti, Ta, or alloys thereof. The plurality of gate wires 122 and 126 can be formed on the insulating substrate 110 by sputtering and are patterned by photo etching.

The plurality of gate wires 122 and 126 may have a multilayered structure including at least two films according to an embodiment of the present invention. For example, a lower film improving adhesion with the insulating substrate 110 can be used. The lower film can be a barrier layer. An upper film preventing a low-resistivity conductive layer and composition materials thereof from being diffused can be used. The upper film can be a capping layer. In an embodiment, a Mo/Al/Mo triple-layered structure may be used. A conductive oxide or nitride may be used as a material of the lower film or the upper film. In an embodiment, an ITO/Ag/ITO triple-layered structure may be used.

A storage electrode line that increases charge storage capability of a pixel may be formed on the same layer as the plurality of gate wires 122, 126 on the insulating substrate 110. The storage electrode line may comprise the same materials as the plurality of gate wires 122, 126, and can be simultaneously deposited and patterned with the gate wires 122, 126. The storage electrode line may have various shapes and arrangements. When storage capacity is sufficient due to overlapping between the pixel electrode 182 and the gate wire 122, forming the storage electrode line may be omitted.

The insulating substrate 110 having the plurality of gate wires 122, 126 is entirely covered with the gate insulating layer 130. The gate insulating layer 130, comprising, for example, silicon nitride or silicon oxide, is formed using, for example, sputtering, reactive sputtering, or chemical vapor deposition (CVD).

A semiconductor layer 140 is disposed on a portion of the gate insulating layer 130 having at least a part overlapping the gate electrode 126. The semiconductor layer 140 comprises a semiconductor material such as, for example, hydrogenated amorphous silicon. Ohmic contact layers 155 and 156 are disposed on the semiconductor layer 140. The ohmic contact layers 155 and 156 may comprise, for example, silicide or n+ hydrogenated amorphous silicon heavily doped with n-type impurity. The ohmic contact layers 155 and 156 cover the semiconductor layer 140, and are separated from and opposite each other with respect to the semiconductor layer 140, thus exposing a part of the semiconductor layer 140.

The semiconductor layer 140 and the ohmic contact layers 155 and 156 are deposited, for example, by sputtering, and patterned by a photo etching process. The ohmic contact layers 155 and 156 may have various shapes, such as, for example, an island or a stripe shape, according to a selected mask process. When the ohmic contact layers 155 and 156 are formed in the island shape, the ohmic contact layers 155 and 156 may be patterned before forming data wires.

Data wires are formed on the ohmic contact layers 155 and 156 and the gate insulation layer 130. The data wires 162, 165, 166 include the data line 162, a source electrode 165, a data pad (not shown), and a drain electrode 166. The data line 162 extends in a second direction, i.e., in a longitudinal direction of FIG. 1A, and transmits a data signal. The source electrode 165 extends toward the top of the ohmic contact layer 155 as a branch of the data line 162. The data pad is connected to one end of the data line 162 and is supplied with a picture image signal from an external device. The drain electrode 166 is spaced apart from the source electrode 165 and is formed on top of the ohmic contact layer 156 opposite the source electrode 165 of the gate electrode 126 or a channel unit of the TFT.

The data line 162 is insulated from the gate line 122 by the gate insulation layer 130 and intersects the gate line 122. The data line 162 forms a pixel together with a neighboring data line 162 and a neighboring gate line 122 at an intersection thereof.

The data wires 162, 165 and 166 may comprise, for example, Al, Cu, Ag, Mo, Cr, Ti, Ta, or alloys thereof. The data wires 162, 165 and 166 may be formed on the insulating substrate 110 by sputtering, and are patterned using the underlying ohmic contact layers 155 and 156 and the semiconductor layer 140, and a photo mask as etching masks according to the selected mask process.

The data wires 162, 165 and 166 may have a multilayered structure including at least two films similar to the structure of the gate wires 122 and 126 described above. A TFT in an embodiment of the present invention includes the gate electrode 126, the semiconductor layer 140 formed on the gate electrode 126, the ohmic contact layers 155 and 156, the source electrode 165, and the drain electrode 166.

A passivation layer 170 is formed on the data wires 162, 165, and 166 and the semiconductor layer 140 that is not covered by the data wires 162, 165, and 166. The passivation layer 170 substantially covers the insulating substrate 110. The passivation layer 170 may comprise, for example, an inorganic insulator such as silicon nitride or silicon oxide, or a photosensitive organic material having a good flatness characteristic. When the passivation layer 170 comprises an organic material, an insulating layer comprising silicon nitride or silicon oxide may be disposed thereunder to increase an insulating characteristic. The passivation layer 170 may be formed by, for example, chemical vapor deposition (CVD), plasma enhanced chemical vapor deposition (PECVD), and coating.

A first contact hole 176 exposing the drain electrode 166 and the data line pad (not shown) may be formed in the passivation layer 170. A second contact hole (not shown) exposing the gate line pad (not shown) via the gate insulating layer 130 may be formed through the passivation layer 170 and the gate insulating layer 130.

The pixel electrode 182 is formed on the passivation layer 170. The pixel electrode 182 is electrically connected to the drain electrode 166 via the first contact hole 176. Electric fields are generated between the pixel electrode 182 supplied with the data voltages and a common electrode 250 of the second substrate 200, thereby changing the orientations of liquid crystals in the liquid crystal layer 300 arranged between the pixel electrode 182 and the common electrode 250.

An auxiliary gate pad (not shown) and an auxiliary data pad (not shown) connected to the gate line pad (not shown) and the data line pad (not shown), respectively, via the second contact hole, are also disposed on the passivation layer 170.

The second substrate 200, which faces and is disposed opposite the first substrate 100, is described.

The black matrix 220 defining a pixel area is disposed on a second insulating substrate 210. The black matrix 220 may comprise an opaque metal such as, for example, Cr or an opaque organic material having carbon black added thereto. The black matrix 220 may comprise, for example, a dual-layered structure in which a first Cr layer and a second organic layer are sequentially stacked, or a multi-layer structure in which two or more different color filters are stacked. The black matrix 220 may have a width large enough to cover the gate line 122, the data line 162, and the TFT Q formed on the first substrate 100. When the black matrix 220 comprises an opaque metal such as, for example, Cr, Cr is deposited on the second insulating substrate 210 and then patterned by photo etching. When the black matrix 220 comprises an organic material, an organic mixture having a photosensitive characteristic may be used. The organic mixture is coated and then patterned by exposure and development.

Red, green, and blue color filters of the color filter pattern 230 are sequentially disposed on the black matrix 220. Each color filter is filled with a pixel area surrounded by the black matrix 220.

The color filter pattern 230 may comprise organic materials. In an embodiment, a photosensitive organic mixture material may be used, followed by patterning by exposure and development. In an embodiment, when three red, green and blue color filters are formed on the black matrix 220, the patterning processing is repeated three times. Alternative examples of the patterning processing of the color filter pattern 230 may include a printing method or an inkjet printing method.

The color filter pattern 230 and the black matrix 220 may be partially overlapped, and an over coating film 240 is formed on the entire surface of the insulating substrate 210 to planarize a stepped surface of the color filter pattern 230 and the black matrix 220 by compensating for step heights therebetween. The overcoat layer 240 may comprise an organic material such as, for example, heat-curable acryl resin, polyimide resin and epoxy resin. The organic material may be applied to the overcoat layer 240 by, for example, a spin coating method.

An electrode is formed on the overcoat layer 240 using a transparent conductive material such as, for example, ITO (indium tin oxide) or IZO (indium zinc oxide). The electrode is formed using, for example, a sputtering or a reactive sputtering method. The common electrode 250 is formed on the color filter pattern 230 and generates an electric field in the LC layer 300 together with the pixel electrode 182 of the first substrate 100 to change the orientations of the LC molecules in the LC layer 300.

Alignment films 190 and 290 are formed on the first substrate 100 and the second substrate 200, respectively. The alignment films 190 and 290 control the orientations of liquid crystals in the LC layer 300 when no voltage is applied to a liquid crystal display. The alignment films 190 and 290 may comprise an organic material (“organic alignment films”), or an inorganic material (“inorganic alignment films”).

An organic alignment film may comprise an organic material, e.g., a polyimide resin. The organic alignment film is formed on each of the pixel electrode 182 of the first substrate 100 and the common electrode 250 of the second substrate 200 using, for example, spin-coating or bar-coating. The organic alignment film may be surface-rubbed to define the initial orientation direction of liquid crystals in the LC layer 300.

An inorganic alignment film may include metal oxide, e.g., magnesium oxide (MgO) or indium tin oxide. In an embodiment of the present invention, silicon oxide (SiOx) such as, for example, SiO₂ or SiO can be used for the inorganic alignment film. The inorganic alignment film has better chemical stability and light stability than the organic alignment film. Thus, a liquid crystal display including the inorganic alignment film can have enhanced reliability. The inorganic alignment film is formed on each of the first substrate 100 and the second substrate 200 using, for example, chemical vapor deposition (CVD), plasma-enhanced CVD (PECVD), or sputtering. The inorganic alignment film may be surface-treated with, for example, an ion beam or laser to define an initial orientation direction of liquid crystals in the LC layer 300. Unlike the organic alignment film, the inorganic alignment film, when surface-treated with the ion beam, does not cause the static electricity.

The first substrate 100 and the second substrate 200 are arranged to face each other with the liquid crystal layer 300 interposed therebetween to form a liquid crystal panel. The distance (i.e., cell gap) between the first substrate 100 and the second substrate 200 of the liquid crystal panel is uniformly maintained by a cell gap maintaining member 410.

The cell gap maintaining member 410 adsorbs ionic impurities floating in the liquid crystal layer 300. That is, while floating in the liquid crystal layer 300, the cell gap maintaining member 410 adsorbs ionic impurities, which reduce a voltage holding ratio of the liquid crystal display and cause a residual DC. Therefore, a voltage holding ratio of the liquid crystal display can be increased and a residual DC can be removed, thereby improving the image quality of the liquid crystal display.

The cell gap maintaining member 410 may be an ion-adsorptive bead spacer. The ion-adsorptive bead spacer is not limited to any particular material or structure, and comprises a material capable of adsorbing ion impurities floating in the liquid crystal layer 300. In an embodiment, the ion-adsorptive bead spacer may be a porous, non-porous, or hollow body comprising an ion-adsorptive polyimide resin, and a plastic material such as, for example, polystyrene, polyethylene, polypropylene, polyester, polyacryl, nylon, or a silicone resin. The ion-adsorptive bead spacer may further include, for example, an acryl resin or an epoxy resin. In an embodiment of the present invention, the ion-adsorptive bead spacer may include components such as various commercially available resins and additives.

The ion-adsorptive bead spacer is interposed within a light-shielding region between the first substrate 100 and the second substrate 200. In an embodiment, the ion-adsorptive bead spacer is disposed in the light-shielding region defined as a region of the first substrate 100 where the gate lines 122, data lines 162, sustain electrode lines (not shown), and thin film transistors are formed, and a region of the second substrate 200 where the black matrix 220 is formed. When the ion-adsorptive bead spacer is shielded by the light-shielding region, a light leakage phenomenon caused by the cell gap maintaining member 410 can be prevented.

A liquid crystal display according to an embodiment of the present invention is described with reference to FIG. 5.

FIG. 5 is a sectional view illustrating a liquid crystal display according to an embodiment of the present invention. The liquid crystal display according to the embodiment of the present invention shown in FIG. 5 is substantially the same as the liquid crystal display according to the embodiment of the present invention shown in FIG. 4 except for a cell gap maintaining member.

Referring to FIG. 5, the liquid crystal display has a liquid crystal panel including the first substrate 100, the second substrate 200, the liquid crystal layer 300 interposed between the first substrate 100 and the second substrate 200 and adjusting the amount of light transmitted through liquid crystals according to a voltage-on or off state, the alignment films 190 and 290 controlling the initial orientation of the liquid crystals in the liquid crystal layer 300, and a cell gap maintaining member 420 maintaining a uniform cell gap between the first substrate 100 and the second substrate 200. A light-shielding region blocking light regardless of the arrangement of the liquid crystals in the liquid crystal layer 300 is defined in the liquid crystal panel.

Similar to the cell gap maintaining member 410, the cell gap maintaining member 420 according to an embodiment of the present invention maintains a uniform cell gap. The cell gap maintaining member 420 absorbs ion impurities floating in the liquid crystal layer 300, thereby increasing the voltage holding ratio of a liquid crystal display and removing the residual DC.

The cell gap maintaining member 420 may be an ion-adsorptive bead spacer. The ion-adsorptive bead spacer comprises a core 421 and an ion-adsorptive film 422 coated on the core 421. The core 421 can be, for example, a porous core, a nonporous core or a hollow core. The core 421 comprises an inorganic material such as, for example, glass, silica, or metal oxide (e.g., magnesium oxide, aluminum oxide) and a plastic material such as, for example, polystyrene, polyethylene, polypropylene, polyester, polyacryl, nylon, or a silicone resin. The ion-adsorptive film 422 is not limited to any particular material or structure, and may include a material capable of adsorbing ion impurities floating in the liquid crystal layer 300 according to an embodiment of the present invention. For example, the ion-adsorptive film 422 may comprise a polyimide resin. The ion-adsorptive film 422 may further include, for example, an acryl resin or an epoxy resin. The ion-adsorptive film 422 may further include components including one or more materials selected from various commercially available resins and additives.

The ion-adsorptive bead spacer including the core 421 and the ion-adsorptive film 422 is interposed within a light-shielding region between the first substrate 100 and the second substrate 200 so that the ion-adsorptive bead spacer is shielded by the light-shielding region defined by the first substrate 100 and the second substrate 200. Thus, a light leakage phenomenon caused by the cell gap maintaining member 420 can be prevented.

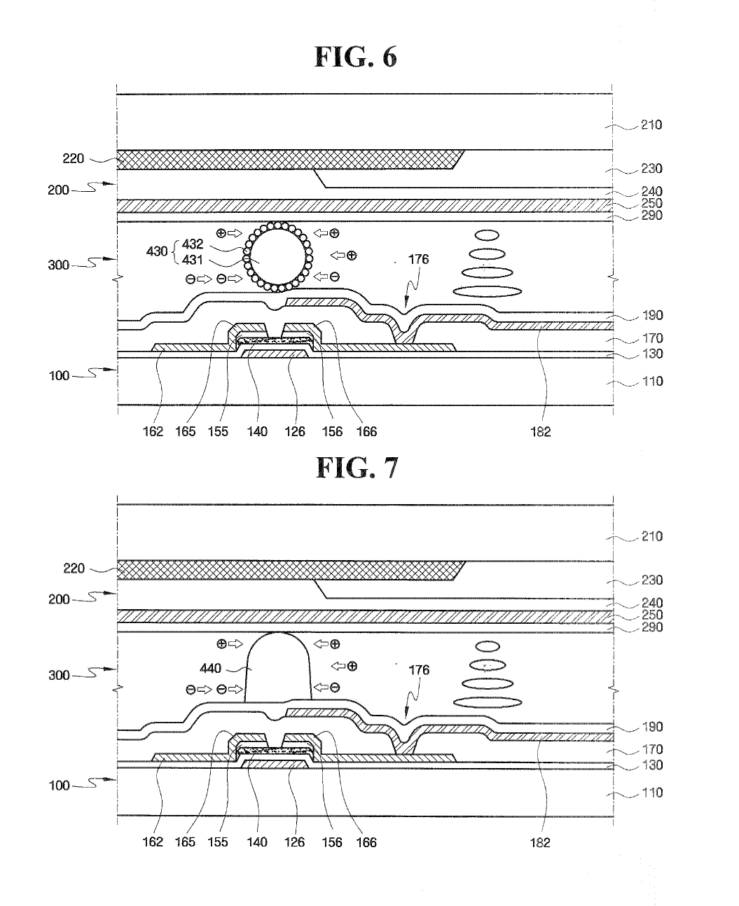

A liquid crystal display according to an embodiment of the present invention is described with reference to FIG. 6. FIG. 6 is a sectional view illustrating a liquid crystal display according to an embodiment of the present invention. The liquid crystal display shown in FIG. 6 is substantially the same as the liquid crystal display shown in FIG. 4 except for a cell gap maintaining member 430.

Referring to FIG. 6, the liquid crystal display has a liquid crystal panel including the first substrate 100, the second substrate 200, the liquid crystal layer 300 interposed between the first substrate 100 and the second substrate 200 and adjusting the amount of light transmitted through the liquid crystals in the liquid crystal layer 300 according to a voltage-on or off state, the alignment films 190 and 290 controlling the initial orientation of the liquid crystals in the liquid crystal layer 300, and the cell gap maintaining member 430 maintaining a uniform cell gap between the first substrate 100 and the second substrate 200. A light-shielding region blocking light regardless of the arrangement of the liquid crystals in the liquid crystal layer 300 is defined in the liquid crystal panel.

Similar to the cell gap maintaining member 410, the cell gap maintaining member 430 maintains a uniform cell gap. The cell gap maintain member 430 can adsorb ion impurities floating in the liquid crystal layer 300, thereby increasing the voltage holding ratio of the liquid crystal display and removing the residual DC.

The cell gap maintaining member 430 may be an ion-adsorptive bead spacer. The ion-adsorptive bead spacer comprises a core 431 and ion-adsorptive microparticles 432 coated on the core 431. The core 431 can be, for example, a porous, a nonporous, or a hollow core. The core 431 comprises an inorganic material such as, for example, glass, silica, or metal oxide, and a plastic material such as, for example, polystyrene, polyethylene, polypropylene, polyester, polyacryl, nylon, or a silicone resin. The ion-adsorptive microparticles 432 have a larger surface area than an ion-adsorptive film (e.g., 422 of FIG. 5), thereby adsorbing more ion impurities than the ion-adsorptive film 422. The ion-adsorptive microparticles 432 is not limited to any particular material or structure, and may include a material capable of adsorbing ion impurities floating in the liquid crystal layer 300 according to an embodiment of the present invention. For example, the ion-adsorptive microparticles 432 may comprise a polyimide resin. The ion-adsorptive microparticles 432 may further include an acryl resin or an epoxy resin. The ion-adsorptive microparticles 432 may further include components including one or more materials selected from various commercially available resins and additives.

The ion-adsorptive bead spacer comprising the core 431 and the ion-adsorptive microparticles 432 is interposed within the light-shielding region between the first substrate 100 and the second substrate 200 so that the ion-adsorptive bead spacer is shielded by the light-shielding region defined in the first substrate 100 and the second substrate 200. Thus, a light leakage phenomenon caused by the cell gap maintaining member 430 can be prevented.

A liquid crystal display according to an embodiment of the present invention is described with reference to FIG. 7.

FIG. 7 is a sectional view illustrating a liquid crystal display according to an embodiment of the present invention. The liquid crystal display shown in FIG. 7 is substantially the same as the liquid crystal display shown in FIG. 4 except for the cell gap maintaining member 440.

Referring to FIG. 7, the liquid crystal display has a liquid crystal panel including the first substrate 100, the second substrate 200, the liquid crystal layer 300 interposed between the first substrate 100 and the second substrate 200 and adjusting the amount of light transmitted through the liquid crystals in the liquid crystal layer 300 according to a voltage-on or off state, the alignment films 190 and 290 controlling the initial orientation of the liquid crystals in the liquid crystal layer 300, and a cell gap maintaining member 440 maintaining a uniform cell gap between the first substrate 100 and the second substrate 200. The light-shielding region blocking light regardless of the arrangement of the liquid crystals in the liquid crystal layer 300 is defined in the liquid crystal panel. Similar to the cell gap maintaining member 410 shown in FIG. 4, the cell gap maintaining member 440 maintains a uniform cell gap. The cell gap maintaining member 440 adsorbs ion impurities floating in the liquid crystal layer 300, thereby increasing the voltage holding ratio of the liquid crystal display and removing the residual DC.

The cell gap maintaining member 440 may be, for example, an ion-adsorptive cylinder spacer. The ion-adsorptive cylinder spacer may comprise a light- or heat-curable resin, and a polymer resin e.g., a polyimide resin, capable of adsorbing ion impurities in the liquid crystal layer 300. For example, the light- or heat-curable resin may be a homopolymer or copolymer including an acrylamide monomer or a vinyl monomer. The ion-adsorptive cylinder spacer may further comprise, for example, an acryl resin and an epoxy resin. The ion-adsorptive cylinder spacer may further comprise components including one or more materials selected from various commercially available resins and additives.

The ion-adsorptive cylinder spacer is interposed within the light-shielding region between the first substrate 100 and the second substrate 200 so that the ion-adsorptive cylinder is shielded by the light-shielding region defined by the first substrate 100 and the second substrate 200. Thus, a light leakage phenomenon caused by the cell gap maintaining member 440 can be prevented.

In liquid crystal displays according to embodiments of the present invention, a cell gap between the first substrate 100 and the second substrate 200 is maintained by a cell gap maintaining member (410, 420, 430, 440 of FIG. 4, 5, 6, 7) having an ion-adsorptive property. Thus, even when inorganic alignment films are respectively disposed on the pixel electrode 182 of the first substrate 100 and the common electrode 250 of the second substrate, a higher voltage holding ratio and a lower residual DC can be achieved due to the adsorption of ion impurities in the liquid crystal layer 300 into the cell gap maintaining member 410, 420, 430 and 440.

Methods of manufacturing liquid crystal displays according to embodiments of the present invention are described. In the methods of manufacturing liquid crystal displays according to embodiments of the present invention, a cell gap maintaining member can be formed within the light-shielding region between the first substrate 100 and the second substrate 200 using, for example, an inkjet printing or an intaglio printing process. A method of manufacturing a liquid crystal display using the inkjet printing process is described with reference to FIGS. 4-6 and 8.

Referring to FIGS. 4 through 6, the first substrate 100 including the thin film transistor and the pixel electrode 182 and the second substrate 200 including the color filter pattern 230 and the common electrode 250 are prepared. The alignment films 190 and 290 are respectively formed on the pixel electrode 182 of the first substrate 100 and the common electrode 250 of the second substrate 200. The alignment films 190 and 290 may be organic alignment films or inorganic alignment films. When the alignment films 190 and 290 are organic alignment films, the alignment films 190 and 290 may include a polyimide resin. When the alignment films 190 and 290 are inorganic alignment films, the alignment films 190 and 290 may include metal oxide such as, for example, magnesium oxide (MgO) or indium tin oxide (ITO), or silicon oxide (SiOx).

Referring to FIGS. 4-6 and 8, a cell gap maintaining member 410, 420 or 430 is formed on at least one of the first substrate 100 and the second substrate 200. The cell gap maintaining member 410, 420 or 430 maintains a cell gap between the first substrate 100 and the second substrate 200 and adsorbs ion impurities in liquid crystals. The cell gap maintaining member may be a porous, a non-porous, or a hollow ion-adsorptive bead spacer comprising, for example, a polyimide resin. In an exemplary embodiment, as shown in FIG. 4, the cell gap maintaining member 410 may be an ion-adsorptive bead spacer comprising a core 421 including a porous core, a nonporous core or a hollow core. In an exemplary embodiment, as shown in FIG. 5, the cell gap maintaining member 420 may be an ion-adsorptive film 422 coated on the core 421 and comprising a polyimide resin. In an exemplary embodiment, as shown in FIG. 6, the cell gap maintaining member 430 may be an ion-adsorptive bead spacer comprising a core 431 including a porous, a nonporous or a hollow core, and the ion-adsorptive microparticles 432 coated on the core 431 and comprising a polyimide resin.

The cell gap maintaining member 410, 420, or 430 is formed within the light-shielding region using the inkjet printing process to prevent a light leakage phenomenon that may be caused by the cell gap maintaining member 410, 420, or 430. For example, when the cell gap maintaining member 410, 420, or 430 is formed on the first substrate 100, the cell gap maintaining member 410, 420, or 430 may overlap gate lines 122, data lines 162, sustain electrode lines (not shown), or thin film transistor regions. For example, when the cell gap maintaining member 410, 420, or 430 is formed on the second substrate 200, the cell gap maintaining member 410, 420, or 430 may overlap the black matrix 220.

A mixture of the cell gap maintaining member 410, 420, or 430, i.e., the ion-adsorptive bead spacer, with an adhesive having a mixture ratio about 0.9 to 1.1 or about 0.95 to 1.05 is supplied onto the alignment film 190 of the first substrate 100 or the alignment film 290 of the second substrate 200 by an inkjet head 610. If the cell gap maintaining member 410, 420, or 430 has an adhesion property, the use of the adhesive may be omitted. The adhesive may be a light- or heat-curable resin. In an embodiment, after being supplied onto the alignment film 190 or 290, the mixture of the cell gap maintaining member 410, 420, or 430 with the adhesive is exposed to light or heat so that the cell gap maintaining member 410, 420, or 430 is fixedly attached to the alignment film 190 or 290.

An inkjet system in an embodiment of the present invention may be a piezo-type inkjet system using a piezoelectric device. The ejection position and amount of spacer substance, e.g., the cell gap maintaining member 410, 420, or 430, in the piezo-type inkjet system can be varied.

After forming the cell gap maintaining member 410, 420, or 430, the first substrate 100 and the second substrate 200 are combined together to complete a liquid crystal panel. In an embodiment, a variety of liquid crystal dispense methods may be used. That is, before combining the first substrate 100 and the second substrate 200, liquid crystals may be dripped onto one of the first substrate 100 and the second substrate 200. Alternatively, after combining the first substrate 100 and the second substrate 200, liquid crystals may be inserted between the first substrate 100 and the second substrate 200.

A method of manufacturing a liquid crystal display according to an embodiment of the present invention is described with reference to FIGS. 7 and 9. The method of manufacturing the liquid crystal display shown in FIG. 9 is substantially the same as the method described in connection with FIGS. 4-6 and 8 except for forming a cylindrical cell gap maintaining member 440.

Referring to FIG. 7, the first substrate 100 having the alignment film 190 and the second substrate 200 having the alignment film 290 are prepared. The alignment films 190 and 290 may be organic alignment films comprising, for example, a polyimide resin, or inorganic alignment films comprising metal oxide, e.g., magnesium oxide (MgO) or indium tin oxide (ITO), or silicon oxide (SiOx).

Referring to FIG. 9, the cylindrical cell gap maintaining member 440 is formed on at least one of the first substrate 100 and the second substrate 200. The cylindrical cell gap maintaining member 440 is formed within the light-shielding region using the inkjet printing process to prevent a light leakage phenomenon that may be caused by the cylindrical cell gap maintaining member 440.

A light- or heat-curable resin and an ion-adsorptive resin, e.g., a polyimide resin, can be mixed with water or a known solution to prepare the resin composition 400. The resin composition 400 is supplied onto the alignment film 190 or 290 by the inkjet head 610. The resin composition 400 is cured by exposure to light or heat while controlling the dot diameter of the resin composition 400 sprayed in the light-shielding region of the first substrate 100 or the second substrate 200, thereby forming the cylindrical cell gap maintaining member 440.

The inkjet system in the above-described inkjet printing process may be a bubble-jet type inkjet system using an electrothermal converter as an energy generating device or a piezo-type inkjet system using a piezoelectric device as an energy generating device. The ejection position and amount of the resin composition 400 as the cell gap maintaining member substance can be varied.

Referring to FIGS. 7 and 9, after forming the cylindrical cell gap maintaining member 440, the first substrate 100 and the second substrate 200 are combined. Before or after combining the first substrate 100 and the second substrate 200, the liquid crystal is inserted between the first substrate 100 and the second substrate 200 to complete a liquid crystal panel.

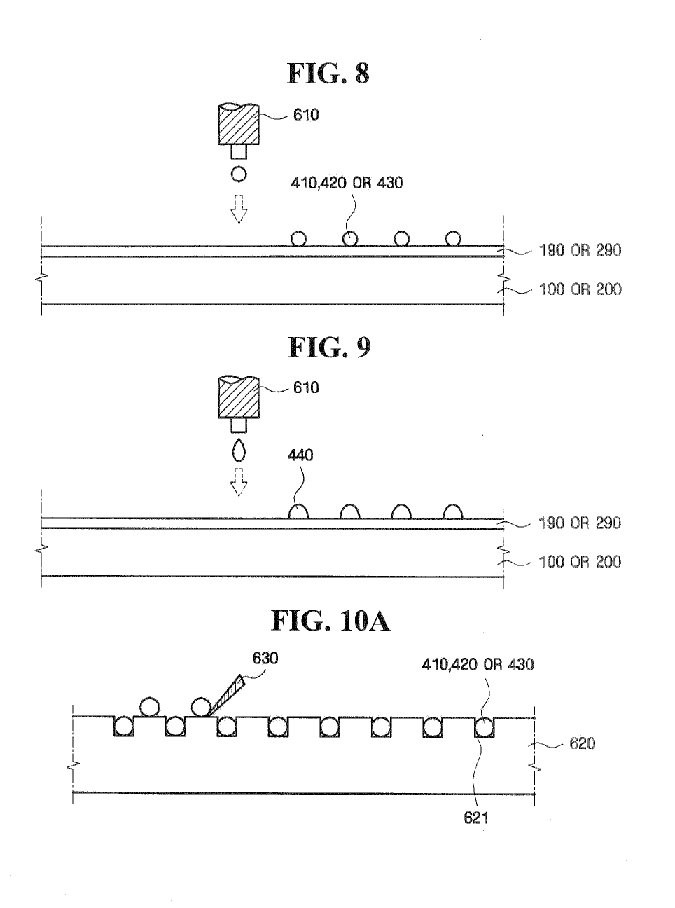

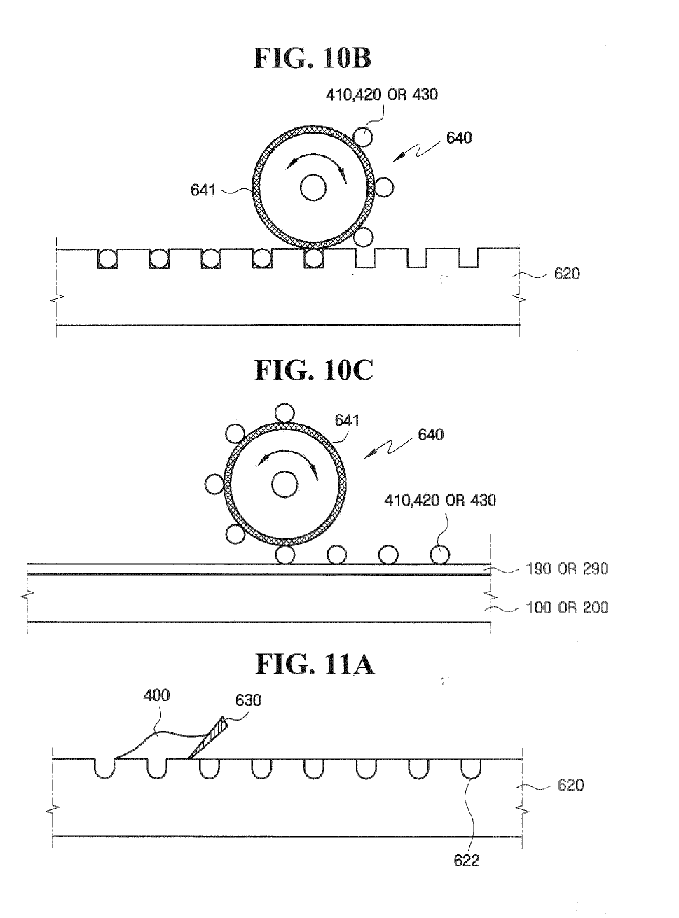

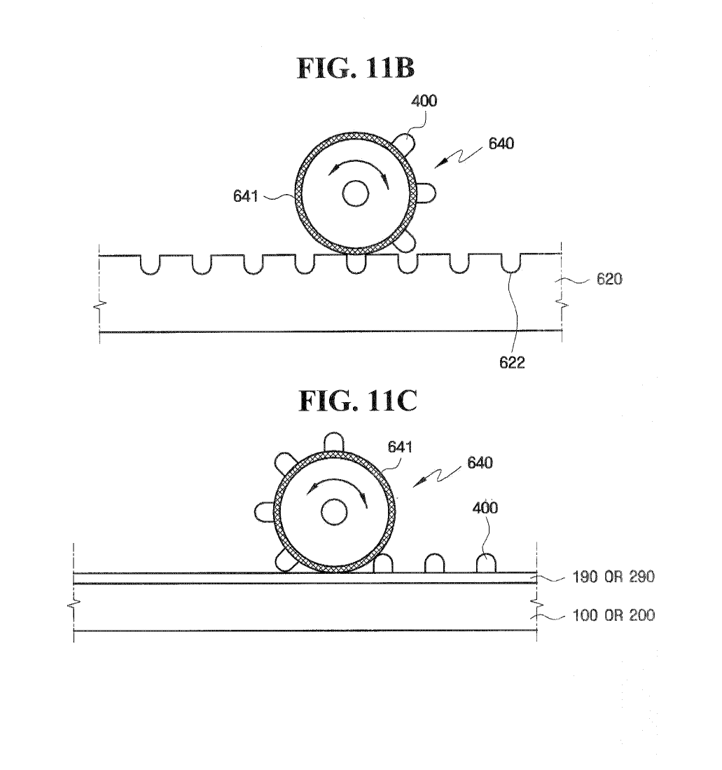

A method of manufacturing a liquid crystal display according to an embodiment of the present invention is described with reference to FIG. 3 and FIGS. 10A through 10C. A method of manufacturing the liquid crystal display shown in connection with FIGS. 10A through 10C is substantially the same as methods described in connection with FIGS. 8 or 9 except that a cell gap maintaining member is formed using the intaglio printing process.

The first substrate 100 having the alignment film 190 and the second substrate 200 having the alignment film 290 are prepared. The alignment films 190 and 290 may be organic alignment films comprising, for example, a polyimide resin, or inorganic alignment films comprising metal oxide, e.g., magnesium oxide (MgO) or indium tin oxide (ITO), or silicon oxide (SiOx).

Referring to FIGS. 10A through 10C, the cell gap maintaining member 410, 420, or 430 is formed on at least one of the first substrate 100 and the second substrate 200. The cell gap maintaining member 410, 420, or 430 is formed within the light-shielding region using the intaglio printing process to prevent a light leakage phenomenon that may be caused by the cell gap maintaining member 410, 420, or 430.

Referring to FIG. 10A, a printing plate 620 with grooves 621 is prepared. To fixedly attach the cell gap maintaining member 410, 420, or 430 to the alignment film 190 or 290 of the first substrate 100 or the second substrate 200, the ion-adsorptive bead spacer is mixed with the light- or heat-curable adhesive in a ratio of about 0.9 to 1.1 or about 0.95 to 1.05, and the mixture is supplied to the printing plate 620. The cell gap maintaining member 410 may be a porous, a non-porous, or a hollow ion-adsorptive bead spacer comprising a polyimide resin, as shown in FIG. 4. The cell gap maintaining member 420 or 430 may be an ion-adsorptive bead spacer comprising a core, and an ion-adsorptive film or ion-adsorptive microparticles, formed on the core and comprising a polyimide resin, as shown in FIGS. 5 and 6. The core may include a porous core, a non-porous core, or a hollow core. If the cell gap maintaining member 410, 420, or 430 has an adhesion property, the use of the adhesive may be omitted. The cell gap maintaining member 410, 420, or 430 is positioned both in the grooves 621 of the printing plate 620 and on an upper surface of the printing plate 620. While moving a blade 630 from one side to the other side of the printing plate 620, the cell gap maintaining member 410, 420, or 430 positioned on the upper surface of the printing plate 620 is filled into the grooves 621, or the residue of the cell gap maintaining member 410. 420, or 430 is removed from the printing plate 620.

Referring to FIG. 10B, a transfer roller 640 is rolled over the printing plate 620 in which the cell gap maintaining member 410, 420, or 430 is filled into the grooves 621. A transfer sheet 641 is attached to an outer surface of the transfer roller 640. Thus, while rolling the transfer roller 640 on the printing plate 620, the cell gap maintaining member 410, 420, or 430 is transferred to the transfer sheet 641.

Referring to FIGS. 10B and 10C, the transfer roller 640 with the cell gap maintaining member 410, 420, or 430 is rolled onto the alignment film 190 of the first substrate 100 or the alignment film 290 of the second substrate 200. The cell gap maintaining member 410, 420, or 430 attached to the transfer sheet 641 is re-transferred to the alignment film 190 or 290. The cell gap maintaining member 410, 420, or 430 re-transferred to the alignment film 190 or 290 is exposed to light or heat to cure the adhesive. As a result, the cell gap maintaining member 410, 420, or 430 is fixed to the alignment film 190 or 290 of the first substrate 100 or the second substrate 200.

After forming the cell gap maintaining member 410, 420, or 430, the first substrate 100 and the second substrate 200 are combined. Before or after combining the first substrate 100 and the second substrate 200, the liquid crystal is inserted between the first substrate 100 and the second substrate 200, thereby completing a liquid crystal panel.

A method of manufacturing a liquid crystal display according to an embodiment of the present invention is described with reference to FIG. 7 and FIGS. 11A through 11C. A method of manufacturing the liquid crystal display according to an embodiment of the present invention shown in connection with FIGS. 11A through 11C is substantially the same as the methods of manufacturing the liquid crystal displays according to previous embodiments of the present invention except for forming a cell gap maintaining member.

Referring to FIG. 7, the first substrate 100 having the alignment film 190 and the second substrate 200 having the alignment film 290 are prepared. The alignment films 190 and 290 may be organic alignment films comprising, for example, a polyimide resin, or inorganic alignment films comprising metal oxide, e.g., magnesium oxide (MgO) or indium tin oxide (ITO), or silicon oxide (SiOx).

Referring to FIGS. 11A through 11C, the cell gap maintaining member 440 is formed on at least one of the first substrate 100 and the second substrate 200. The cell gap maintaining member 440 is formed within the light-shielding region using the intaglio printing process to prevent a light leakage phenomenon that may be caused by the cell gap maintaining member 440.

Referring to FIG. 11A, the printing plate 620 with grooves 622 is prepared. The resin composition 400 comprising a light- or heat-curable resin and an ion-adsorptive polymer resin, e.g., a polyimide resin, is supplied on the printing plate 620 by a supplier (not shown) The light- or heat-curable resin is the same as described above. While moving the blade 630 from one side to the other side of the printing plate 620, the resin composition 400 is filled into the grooves 622 and the residue of the resin composition 400 is removed from the printing plate 620.

Referring to FIG. 11B, the transfer roller 640 is rolled over the printing plate 620 in which the resin composition 400 is filled into the grooves 622. The transfer sheet 641 is attached to an outer surface of the transfer roller 640. Thus, while the transfer roller 640 is rolled over the printing plate 620, the resin composition 400 filled into the grooves 622 is transferred to the transfer sheet 641.

Referring to FIG. 11C, the transfer roller 640 with the patterned resin composition 400 is rolled onto the alignment film 190 of the first substrate 100 or the alignment film 290 of the second substrate 200. As a result, the resin composition 400 attached to the transfer sheet 641 are re-transferred to the alignment film 190 or 290. The resin composition 400 is cured by exposure to light or heat, thereby completing the cylindrical cell gap maintaining member 440 fixedly attached onto the alignment film 190 or 290.

Referring to FIGS. 7 and 11A through 11C, after forming the cell gap maintaining member 440, the first substrate 100 and the second substrate 200 are combined. Before or after combining the first substrate 100 and the second substrate 200, the liquid crystal is inserted between the first substrate 100 and the second substrate 200, thereby completing a liquid crystal panel.

In methods of manufacturing liquid crystal displays according to embodiments of the present invention, an ion-adsorptive cell gap maintaining member is formed on an alignment film. Thus, even when the alignment film is an inorganic alignment film, ion impurities in a liquid crystal layer can be adsorbed to the cell gap maintaining member, thereby achieving a liquid crystal display with a higher voltage holding ratio and a lower residual DC.

According to liquid crystal displays of embodiments of the present invention, ion impurities floating in a liquid crystal layer can be adsorbed to a cell gap maintaining member, thereby increasing a voltage holding ratio and decreasing a residual DC. Therefore, liquid crystal displays according to embodiments of the present invention exhibit better brightness and no afterimage on a screen.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A liquid crystal display having a liquid crystal panel, the liquid crystal panel comprising:
a first substrate and a second substrate facing each other with liquid crystals interposed therebetween, wherein a light-shielding region that blocks light regardless of the arrangement of the liquid crystals is defined in each of the first substrate and the second substrate; and
an ion-adsorptive cell gap maintaining member interposed between the first substrate and the second substrate so that the ion-adsorptive cell gap maintaining member is shielded by the light-shielding region of the first substrate or the second substrate.

2. The liquid crystal display of claim 1, wherein the cell gap maintaining member is an ion-adsorptive bead spacer.

3. The liquid crystal display of claim 2, wherein the ion-adsorptive bead spacer comprises a core, and an ion-adsorptive film or ion-adsorptive microparticles disposed on the core.

4. The liquid crystal display of claim 3, wherein the ion-adsorptive film or the ion-adsorptive microparticles comprise a polyimide resin.

5. The liquid crystal display of claim 4, wherein an inorganic alignment film is interposed between the cell gap maintaining member and each of the first substrate and the second substrate.

6. The liquid crystal display of claim 5, wherein the inorganic alignment film comprises silicon oxide.

7. The liquid crystal display of claim 1, wherein the cell gap maintaining member comprises a light- or heat-curable polyimide resin.

8. The liquid crystal display of claim 7, wherein an inorganic alignment film is interposed between the cell gap maintaining member and each of the first substrate and the second substrate.

9. The liquid crystal display of claim 8, wherein the inorganic alignment film comprises silicon oxide.

10. The liquid crystal display of claim 1, wherein an inorganic alignment film is interposed between the cell gap maintaining member and each of the first substrate and the second substrate.

11. A method of manufacturing a liquid crystal display having a liquid crystal panel, the method comprising:
forming an ion-adsorptive cell gap maintaining member between a first substrate and a second substrate, each substrate comprising a light-shielding region blocking light regardless of an arrangement of liquid crystals, wherein the ion-adsorptive cell gap maintaining member is shielded by the light-shielding region of the first substrate or the second substrate; and
combining the first substrate and the second substrate together.

12. The method of claim 11, wherein the cell gap maintaining member is an ion-adsorptive bead spacer.

13. The method of claim 12, wherein the ion-adsorptive bead spacer comprises a core, and an ion-adsorptive film or ion-adsorptive microparticles disposed on the core.

14. The method of claim 13, wherein the ion-adsorptive film or the ion-adsorptive microparticles comprise a polyimide resin.

15. The method of claim 14, wherein the cell gap maintaining member is formed within the light-shielding region using an intaglio printing process or an inkjet printing process.

16. The method of claim 15, further comprising forming an inorganic alignment film between the cell gap maintaining member and each of the first substrate and the second substrate.

17. The method of claim 11, wherein the cell gap maintaining member comprises a light- or heat-curable resin.

18. The method of claim 17, wherein the cell gap maintaining member is formed within the light-shielding region using an intaglio printing process or an inkjet printing process.

19. The method of claim 18, further comprising forming an inorganic alignment film between the cell gap maintaining member and each of the first substrate and the second substrate.

20. The method of claim 11, further comprising forming an inorganic alignment film between the cell gap maintaining member and each of the first substrate and the second substrate.
